(19) United States
(12) Patent Application Publication
(10) Pub. No.: US 2009/0032424 A1
(43) Pub. Date: Feb. 5, 2009

(54) INDIVIDUAL AND UNIVERSAL LIPSTICK TUBE CASES

(76) Inventor: Olive Anne McLaughlin, Dallas, TX (US)

Correspondence Address: MICHAEL A. O'NEIL, P.C., 5949 SHERRY LANE, SUITE 820, DALLAS, TX, 75225, US

(21) Appl. No.: 12/184,393

(22) Filed: Aug. 1, 2008

Related U.S. Application Data
(60) Provisional application No. 60/953,751, filed on Aug. 3, 2007.

(51) Int. Cl. B65D 85/72; A45D 40/06; B43K 23/00

(52) U.S. Cl. 206/385; 401/68; 401/98; 401/88

(57) ABSTRACT

A lipstick tube case comprises a housing for receiving the tube of lipstick therein, means for securing the tube of lipstick within the housing such as tension clips or graduated o-rings, and a cover removably coupled to the housing for maintaining moisture therein. The housing of the lipstick tube case may further comprise a shaft which receives the shaft of the tube of lipstick, the shaft comprising means for engaging and rotating the shaft of the tube of lipstick. The means for securing the tube of lipstick within the housing is capable of receiving and engaging various sizes and styles of lipsticks.

### CROSS-REFERENCE TO RELATED APPLICATION

Applicant claims priority based on provisional patent application Ser. No. 60/953,751 filed Aug. 3, 2007, the entire content of which is incorporated herein by reference.

### BRIEF DESCRIPTION OF THE DRAWINGS

For a more complete understanding of the present invention, including its features and advantages, reference is now made to the detailed description of the invention taken in conjunction with the accompanying drawing in which:

FIG. 1 is section view illustrating a universal lipstick tube case comprising one embodiment of the present invention;

FIG. 1A is an exploded view of the universal lipstick tube case shown in FIG. 1;

FIG. 2 is section view illustrating a universal lipstick tube case comprising another embodiment of the present invention;

FIG. 2A is an exploded view of the universal lipstick tube case shown in FIG. 2;

FIG. 3 is section view illustrating a universal lipstick tube case comprising yet another embodiment of the present invention;

FIG. 3A is an exploded view of the universal lipstick tube case shown in FIG. 3;

FIG. 4 is section view illustrating a universal lipstick tube case comprising yet another embodiment of the present invention;

FIGS. 5 and 6 are pictures of three example embodiments of the present invention;

FIG. 7 is a picture of two more example embodiments of the present invention;

FIGS. 8-9 are diagrams of yet another embodiment of the present invention;

FIG. 10 is a diagram of yet another embodiment;

FIG. 11 is a diagram of yet another embodiment; and

FIG. 12 is a diagram of yet another embodiment

### DETAILED DESCRIPTION

While the making and using of various embodiments of the present invention are discussed in detail below, it should be appreciated that the present invention provides many applicable inventive concepts that may be embodied in a wide variety of specific contexts. The specific embodiments discussed herein are merely illustrative of specific ways to make and use the invention and do not delimit the scope of the invention.

Currently available lipstick tubes comprise a wide variety of sizes and styles. Each manufacturer has its own signature design for its lipstick tubes, generally comprising a base and a cover received thereon. Most lipstick tubes are metallic or plastic and comprise a simple appearance which may or may not include the manufacturer's name and/or logo.

Women often desire a more fashionable appearance for their lipsticks. Heretofore, women have been required to purchase fashion accessories such as decorative lipstick tube cases as a decorative alternative to the simple appearance of most lipstick tubes. Lipstick tube cases have not gained wide acceptance in part because they require the additional step of removing the lipstick from the case before it can be used and the subsequent step of returning the lipstick tube to the case.

An embodiment of the present invention comprises individual and universal lipstick tube cases which overcome the foregoing and other difficulties which have long since characterized the prior art. In accordance with the broader aspects of the invention a universal lipstick tube case comprises a housing for receiving and securing a tube of lipstick therein and a cover removably coupled to the housing for maintaining moisture in the lipstick.

In accordance with more specific aspects of the invention the housing comprises a base for receiving the base of the lipstick tube. The base comprises securing means such as tension clips or graduated o-rings for receiving and securing the lipstick tube therein. The housing may include a cylinder rotatably supported on the base for engaging and rotating the lipstick tube to extend the lip color from the top thereof.

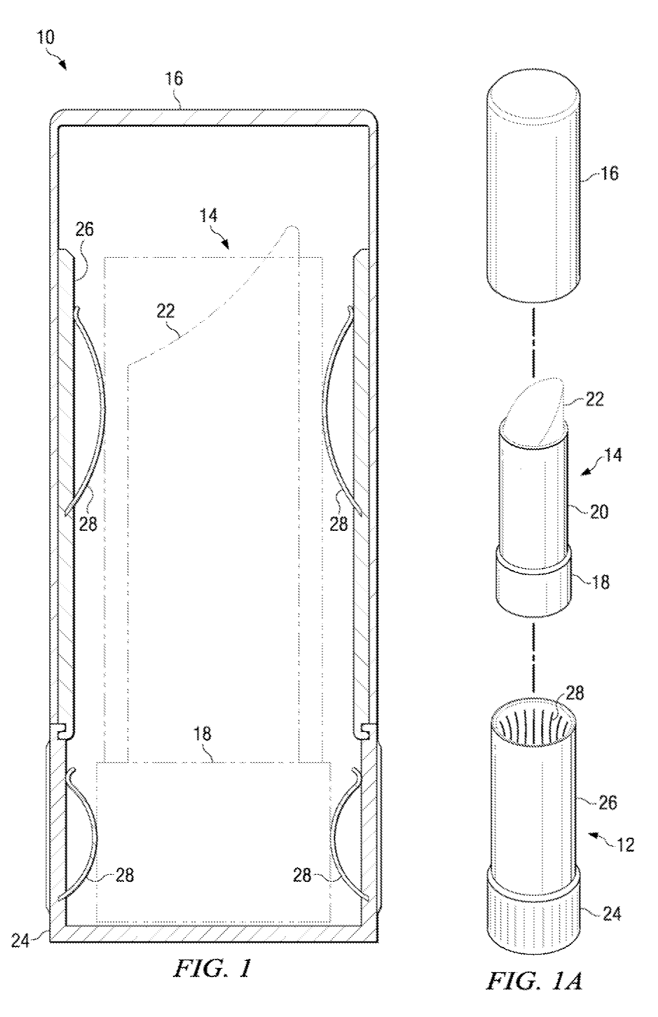

Now referring to the Drawings, and particularly to FIGS. 1 and 1A thereof, a universal lipstick tube case 10 is shown comprising one embodiment of the present invention. The lipstick tube case 10 includes a housing 12 for receiving a tube of lipstick 14 therein and a cover 16 for receiving the housing 12 to retain moisture therein. The tube of lipstick 14 comprises a stationary base 18 and a rotating cylinder 20 coupled thereto housing a stick of lip color 22. The housing 12 likewise comprises a housing base 24 and a cylinder 26 rotatably coupled thereto.

Mounted within the housing base 24 and the cylinder 26 are a plurality of tension clips 28 for engaging and maintaining the tube of lipstick 14 in engagement within the housing 12. To protrude the lip color 22 from the housing 12 the housing shaft 26 is rotated in a counterclockwise direction thereby rotating the cylinder 20 of the lipstick 14 in a manner well known to those skilled in the art of applying lipstick. The tension clips 28 are capable of receiving and engaging various sizes and shapes of lipstick tubes thereby enabling the lipstick tube case 10 to accommodate various sizes and shapes of lipsticks.

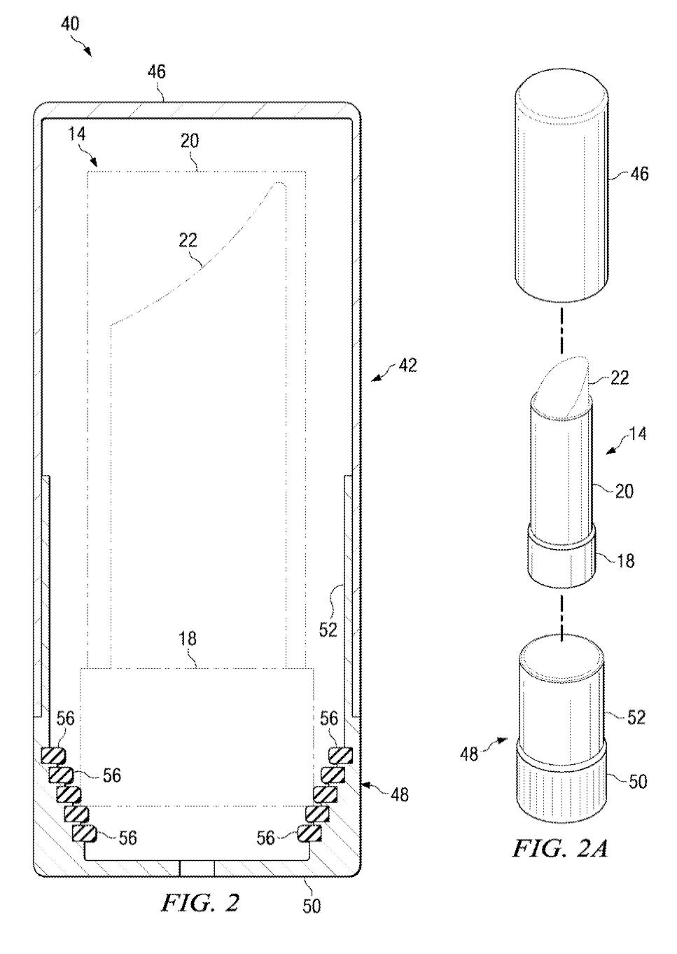

Now referring to FIGS. 2 and 2A, a universal lipstick tube case 40 is shown comprising another embodiment of the present invention. The lipstick tube case 40 comprises a housing 42 for receiving the tube of lipstick 14 therein mid a cover 46 for removably receiving the housing 42 to retain moisture therein. The housing 42 comprises a base 48 with a lower portion 50 and an upper portion 52, the lower portion 50 comprising graduated o-rings 56 mounted therein for receiving the base 18 of the tube of lipstick 14 and thereafter maintaining the tube of lipstick 14 securely engaged within the housing 42. The graduated o-rings 56 comprise various sizes in order to accommodate various sizes and shapes of tubes of lipsticks. To protrude the lip color 22 the cylinder 20 is rotated in a counterclockwise direction in the same manner as is well-known by those skilled in the art of applying lipstick.

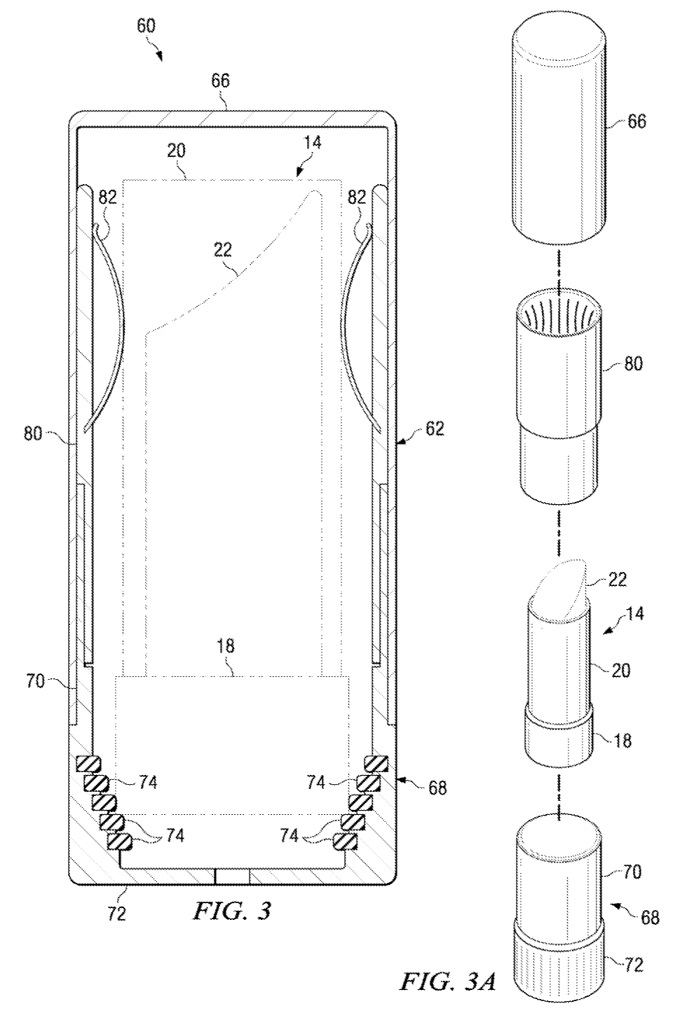

Now referring to FIGS. 3 and 3A, a universal lipstick tube case 60 is shown comprising yet another embodiment of the present invention. The lipstick tube case 60 comprises a housing 62 for receiving the tube of lipstick 14 therein and a cover 66 for removably receiving the housing 62 to retain moisture therein. The housing 62 comprises a base 68 having an upper portion 70 and a lower portion 72, the lower portion comprising graduated o-rings 74 mounted therein for receiving the base 18 of the tube of lipstick 14 and thereafter maintaining the tube of lipstick 14 securely engaged in the housing 62. The graduated o-rings 74 comprise various sizes to accommodate various sizes and shapes of tubes of lipsticks. Rotatably coupled on the upper portion 70 of the base 68 is a cylinder 80 having tension clips 82 mounted therein for engaging the cylinder 20 of the tube of lipstick 14. To protrude the lip color 22 from the housing 62, the cylinder 80 is rotated in a counterclockwise direction thereby engaging and rotating the cylinder 20 of the lipstick 14 in a manner well known to those skilled in the art of applying lipstick.

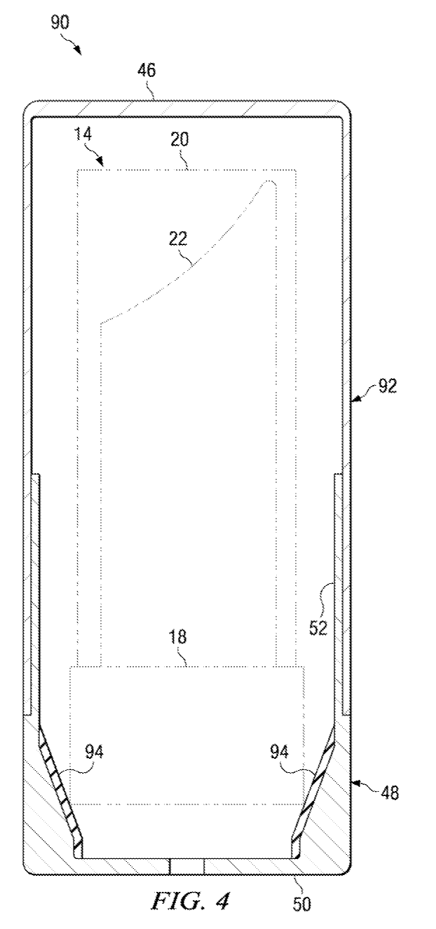

Now referring to FIG. 4, a universal lipstick tube case 90 is shown comprising still another embodiment of the present invention. The lipstick tube case 90 comprises a housing 92 for receiving the tube of lipstick 14 therein. The lipstick tube case 90 differs from the lipstick tube case 60 in that in lieu of the o-rings of the lipstick tube case 60 the lipstick tube case 90 is provided with a funnel shaped member 94 formed from a resilient material which grippingly engages the base 18 of the lipstick tube 14 thereby securing the lipstick tube 14 in the lipstick tube case 90.

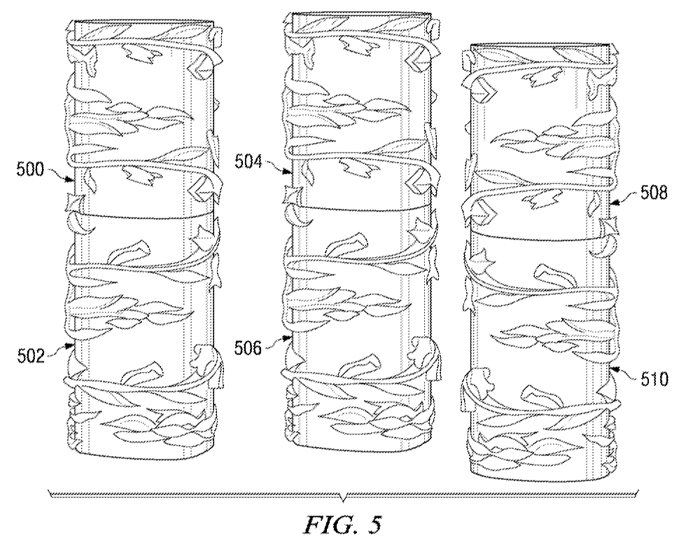

Now referring to FIG. 5, three example universal lipstick tube cases are shown. The leftmost case has a cover 500 and a base 502. Similarly, the center also has a cover 504 and a base 506 while the rightmost case has a cover 508 and a base 510. In this embodiment, all three examples have decorative vines with leaves encrusted throughout the covers and bases.

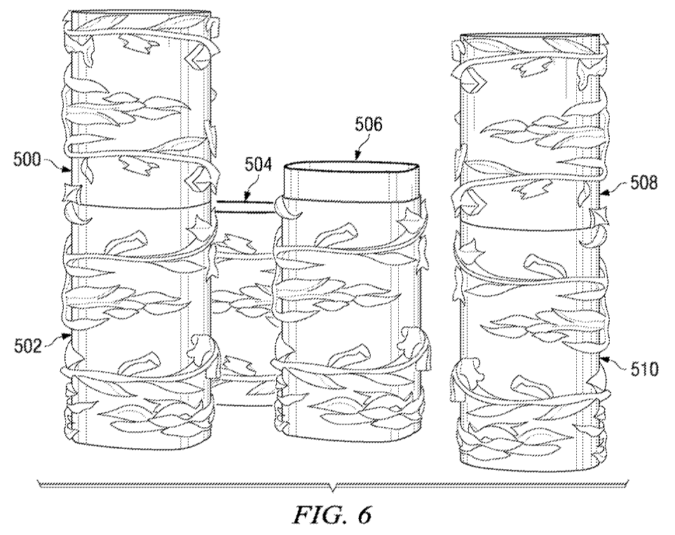

Now referring to FIG. 6, the same three example cases are shown as in FIG. 5, but the cover 504 of the middle case is off of the base 506

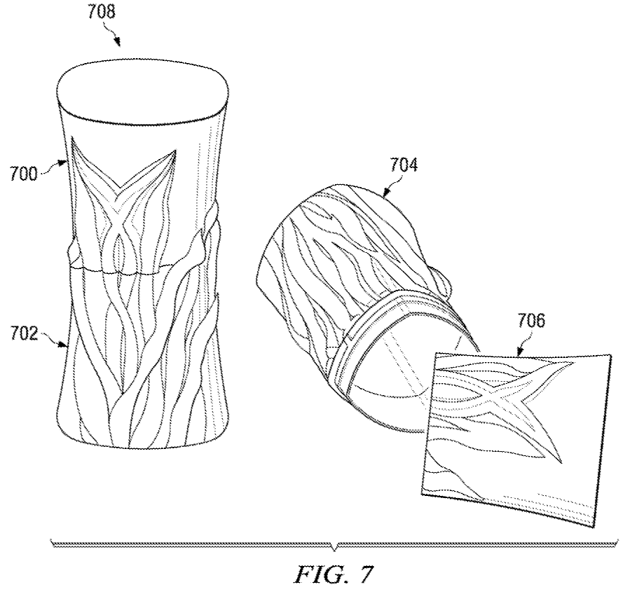

Now referring to FIG. 7, two more example cases are shown. The leftmost case has a cover 700 and a base 702. The rightmost case is shown with the cover 706 shown besides the base 704. These examples include a curved design with decorative vines and a magnifying mirror finish on the top of the cover 700. Thus, this mirror finish could be used to help a person apply the lipstick.

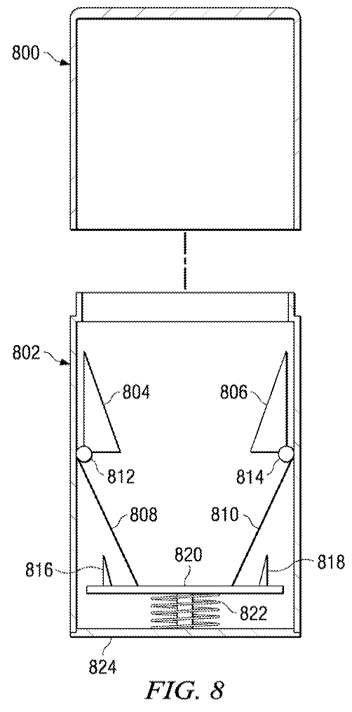

Now referring to FIG. 8, an alternate embodiment is shown. This embodiment has a cover 800 and a base 802. The base 802 has two clear rubber pads 804, 806 and two supports 808, 810, each connected to a respective hinge 812, 814. In addition, this embodiment includes two protrusions 816, 818 on a support 820 with a locking spring 822 and a release 824.

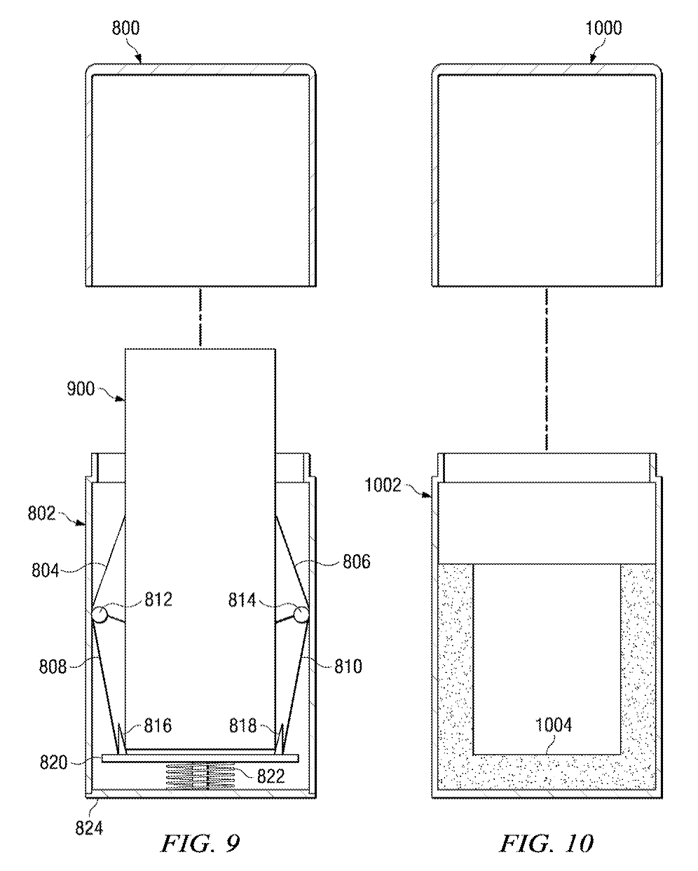

Now referring to FIG. 9, when a lipstick case 900 is inserted into the base 802, the pads 804, 806 rotate inward snugly against the case 900. Moreover, the supports 808, 810 move outward over the protrusions 816, 818 to lock the spring 822 into place. When the lipstick case 900 needs to be removed from the base 802, the release 824 is pulled away from the base in order to release the locking spring 822.

Now referring to FIG. 10, another embodiment is shown. In this embodiment, a cover 1000 is shown with a base 1002. However, in the base, a foam like material 1004 is included within the base 1002 in order to snugly surround a lipstick case when it is inserted into the base 1002.

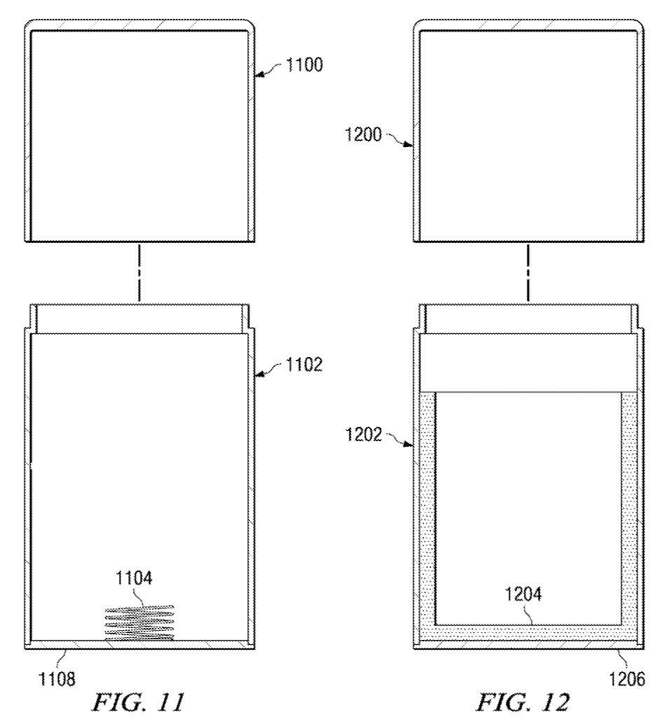

Now referring to FIG. 11, another embodiment is shown. In this embodiment, a cover 1100 and a base is also shown. However, this base 1102 includes a locking spring 1104 with a release 1108. This embodiment is similar to the embodiment in FIG. 8 where once a lipstick case is inserted into the base 1102, the spring 1104 locks into place. Consequently, when the lipstick case is to be removed, the release 1108 is pulled away from the base 1102 to release the locking spring 1104.

Now referring to FIG. 12, another embodiment is shown. In this embodiment, a cover 1200 and a base 1202 is shown. However, this base 1202 includes an insert 1204 can expand when an activator 1206 is rotated in order to snugly hold a lipstick tube once it is inserted.

The universal lipstick tube cases described above may all comprise an infinite combination of ornamentations and colors such as metals, decorative objects, and other decorative features on the housings. Accordingly, the lipstick tube case of the present invention enables a user to achieve a fashionable look for any different lipstick the user may select while maintaining the lipstick securely therein.

The present invention is illustrated in the drawings and described hereinabove in conjunction with universal lipstick tube covers. However, as will be appreciated by those skilled in the art, the invention is equally applicable to individual lipstick tube cases, that is, lipstick tube cases designed and manufactured for use in conjunction with specific lipstick tubes. For example, individual lipstick tube covers could be designed and manufactured for use in conjunction with lipstick tubes identified with specific manufacturers. In addition, although not specifically shown, an optional hole in the base of each embodiment can be utilized in order to avoid creating a vacuum when inserting the lipstick tube into the base.

Although preferred embodiments of the invention have been illustrated in the accompanying Drawings and described in the foregoing Detailed Description, it will be understood that the invention is not limited to the embodiments disclosed, but is capable of numerous rearrangements, modifications, and substitutions of parts and elements without departing from the spirit of the invention.

1. A universal lipstick tube case for receiving a lipstick tube comprising a base, a cylinder rotatably supported on the base, the case comprising:
a housing for receiving the base of the lipstick therein;
securing mechanism within the housing for receiving and maintaining a lipstick tube therein; and
a cover removably receiving the housing.

2. The universal lipstick tube case according to claim 1 wherein the securing mechanism comprises graduated o-rings mounted within the lower portion of the housing base.

3. The universal lipstick tube case according to claim 1 wherein the securing mechanism comprises tension clips mounted within the lower portion of the base.

4. The universal lipstick tube case of claim 1 wherein the securing mechanism is a locking spring and pads rotated snugly against the lipstick tube.

5. The universal lipstick tube case of claim 1 wherein the securing mechanism is a foam insert within the base.

6. The universal lipstick tube case according to claim 1 further comprising ornamentation on the base and cap.

7. A universal lipstick tube case for receiving a tube of lipstick comprising a base and housing within a shaft rotatably coupled to the base comprising:
a housing for receiving the base of the tube of lipstick therein;
securing mechanism for receiving and maintaining the base of the lipstick tube within the housing;
a cover removably coupled to the housing; and
engaging means for engaging a shaft of the lipstick tube to protrude a lip color therefrom.

8. The universal lipstick tube case according to claim 7 wherein the housing comprises a base having a shaft rotatably coupled thereto.

9. The universal lipstick tube case according to claim 7 wherein the securing mechanism comprises tension clips within the housing.

10. The universal lipstick tube case according to claim 7 wherein the securing mechanism comprises graduated o-rings mounted within a base of the housing.

11. The universal lipstick tube case according to claim 7 wherein the means for engaging the tube of lipstick comprises tension clips mounted within a shaft of the housing.

12. The universal lipstick tube case of claim 7 wherein the securing mechanism is a locking spring and pads rotated snugly against the lipstick tube.

13. The universal lipstick tube case of claim 7 wherein the securing mechanism is a foam insert within the base.

14. The universal lipstick tube case according to claim 7 further comprising ornamentation on the base and cap.
